(19) United States
(12) Patent Application Publication
(10) Pub. No.: US 2026/0170516 A1
(43) Pub. Date: Jun. 18, 2026

(54) SYSTEMS AND METHODS FOR DETERMINING CONSUMER SENTIMENT

(71) Applicant: ALLSTATE INSURANCE COMPANY, NORTHBROOK, IL (US)

(72) Inventors: Atul S. Deshmukh, Naperville, IL (US); Sharon J. Dean, Lindenhurst, IL (US); Marybeth Wolff, Round Lake, IL (US); Brian J. Dees, Wheeling, IL (US)

(21) Appl. No.: 19/416,206

(22) Filed: Dec. 11, 2025

Related U.S. Application Data
(60) Provisional application No. 63/734,276, filed on Dec. 16, 2024.

(51) Int. Cl. G06Q 30/0201

(52) U.S. Cl. CPC G06Q 30/02012

(57) ABSTRACT

Aspects of the disclosure relate to systems and/or methods for determining consumer sentiment. For example, one or more machine learning models may analyze data to identify consumer sentiment associated with a transaction pathway corresponding with a transaction. The data may include at least one of structured data or unstructured data. Using the one or more machine learning models and processed consumer sentiment data stored in a database, the computing system may predict one or more transaction steps that include a score above a predetermined consumer sentiment threshold. A processing engine may receive feedback from the one or more machine learning models and the database to determine a recommend transaction pathway comprising the one or more predicted transaction steps. The computing system may monitor consumer sentiment data associated with the recommended transaction pathway until a consumer completes the recommended transaction pathway.

### CROSS-REFERENCE TO RELATED APPLICATIONS

This claims priority to U.S. Provisional Patent Application No. 63/734,276 , filed on Dec. 16, 2024, the entire contents of which are incorporated by reference herein.

### FIELD

This invention generally relates to systems and methods for determining consumer sentiment.

### BACKGROUND

Traditional approaches to determining consumer sentiment for transactions face significant technical and practical limitations that impact the ability to accurately understand consumer sentiment for transaction experiences. Current methods often rely heavily on structured data sources, such as standardized surveys and rating systems, which may not capture the full spectrum of consumer sentiment and experiences associated with complex transactions. While unstructured consumer sentiment data from sources like free-from text surveys, chat conversations, phone calls, and other communications contain valuable insights into actual consumer experiences, analyzing such data presents substantial computational challenges.

Further, manual review of large volumes of unstructured text data request significant computer processing time and human resources, making it impractical for real-time analysis or large-scale sentiment assessment. Similar, traditional keyword search strategies for processing unstructured consumer sentiment data often fail to achieve high accuracy due to a large variation in vocabulary and expression that consumers use when describing their experiences. These limitations in efficiently and accurately processing consumer sentiment data hinder the ability to identify optimal transaction experiences that could improve customer satisfaction, loyalty, and retention. Furthermore, existing approaches typically lack the capability to provide real-time sentiment monitoring and dynamic transaction pathway adjustments during ongoing transactions, potentially missing opportunities to address negative or non-positive consumer sentiment during the process of the transaction.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present disclosure provides, in one aspect, a computing system comprising: a processor, a memory storing computer-executable instructions that, when executed by the processor, cause the processor to: receive, by a computing device, data associated with a transaction pathway from one or more data sources, the data including at least one of structured data or unstructured data, analyze, by the computing device and via a machine learning model, the at least one of the structured data or the unstructured data to identify at least one type of consumer sentiment associated with the transaction pathway, the machine learning model trained on historical transaction pathway data and historical consumer sentiment data. The computing system also causes the processor to store, by the computing device and based on the analysis, processed consumer sentiment data in a database, predict, by the computing device and via the machine learning model and based on the processed consumer sentiment data, one or more transaction steps, wherein each of the one or more transaction steps include a corresponding score above a predetermined consumer sentiment threshold. The computing system also causes the processor to determine, by the computing device and via a processing engine in communication with the machine learning model and the database, a recommended transaction pathway that comprises the one or more transaction steps characterized by the corresponding score above the predetermined consumer sentiment threshold, and monitor, by the computing device, consumer sentiment data associated with recommended transaction pathway until a consumer completes the recommended transaction pathway.

The present disclosure provides, in another aspect, a method comprising: receiving, by a computing device, data associated with a transaction pathway from one or more data sources, the data including at least one of structured data or unstructured data, analyzing, by the computing device and via a machine learning model, the at least one of the structured data or the unstructured data to identify at least one type of consumer sentiment associated with the transaction pathway, the machine learning model trained on historical transaction pathway data and historical consumer sentiment data. The method also includes storing, by the computing device and based on the analyzing, processed consumer sentiment data in a database, predicting, by the computing device and via the machine learning model and based on the processed consumer sentiment data, one or more transaction steps, wherein each of the one or more transaction steps include a corresponding score above a predetermined consumer sentiment threshold. The method also includes determining, by the computing device and via a processing engine in communication with the machine learning model and the database, a recommended transaction pathway that comprises the one or more transaction steps characterized by the corresponding score above the predetermined consumer sentiment threshold, and monitoring, by the computing device, consumer sentiment data associated with the recommended transaction pathway until a consumer completes the recommended transaction pathway.

The present disclosure provides, in another aspect, one or more non-transitory computer-readable media storing instructions that, when executed by a processor, cause the processor to: receive, by a computing device, data associated with a transaction pathway from one or more data sources, the data including at least one of structured data or unstructured data, analyze, by the computing device and via a machine learning model, the at least one of the structured data or the unstructured data to identify at least one type of consumer sentiment associated with the transaction pathway, the machine learning model trained on historical transaction pathway data and historical consumer sentiment data. The one or more non-transitory computer-readable media storing instructions, when executed by the processor, also cause the processor to store, by the computing device and based on the analysis, processed consumer sentiment data in a database, predict, by the computing device and via the machine learning model and based on the processed consumer sentiment data, one or more transaction steps, wherein each of the one or more transaction steps include a corresponding score above a predetermined consumer sentiment threshold. The one or more non transitory computer-readable media storing instructions, when executed by the processor, also cause the processor to determine, by the computing device and via a processing engine in communication with the machine learning model and the database, a recommended transaction pathway that comprises the one or more transaction steps characterized by the corresponding score above the predetermined consumer sentiment threshold; and monitor, by the computing device, consumer sentiment data associated with the recommended transaction pathway until a consumer completes the recommended transaction pathway.

The arrangements described can also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 illustrates a computing environment for a pathway determination system according to one or more embodiments.

FIG. 2 illustrates components of a computing platform according to an embodiment.

FIG. 3 illustrates a data flow diagram showing the transfer of data between one or more data sources, a database, and a computing platform according to one or more embodiments.

FIG. 4 is a flow chart illustrating a method for determining a pathway for a transaction using a consumer sentiment determination engine according to one or more embodiments.

FIG. 5 is a flow chart illustrating a method for determining a pathway for a transaction using a consumer sentiment determination engine according to one or more embodiments.

FIG. 6 illustrates a data flow diagram showing the transfer of data between one or more data sources, a pathway determination system, and a historical database according to one or more embodiments.

FIG. 7 is a flow chart illustrating a method for collecting and analyzing consumer sentiment data for transactions according to one or more embodiments.

FIG. 8 is a flow chart illustrating a method for guiding consumers on one or more transaction pathways according to one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Described herein are systems and methods for determining one or more pathways comprising one or more steps that guide consumers through a product, sales, or service transaction (generally referred to as “transaction”). The systems and methods described in this disclosure may determine consumer sentiment for any step in a transaction and/or data associated with one or more transactions. For example, the system may determine positive or non-positive consumer sentiment for the one or more pathways and/or the one or more steps. The systems and methods described herein may use a processing engine that analyzes transaction data (e.g., products, sales, or services) and the associated consumer sentiment data to determine desirable pathways for transactions. More specifically, the systems and methods may use a consumer sentiment determination engine to analyze unstructured consumer sentiment data (e.g., free form text data, text files, converted text data from audio or online chat conversations, survey data) associated with transactions. The consumer sentiment determination engine and/or the processing engine allows an enterprise to improve understanding of consumer sentiment for one or more transactions.

In some cases, understanding consumer sentiment may be difficult to discern from structured data (e.g., data table or tabular data) associated with transactions. Unstructured data may accurately capture consumer sentiment associated with transactions as compared to structured data. However, unstructured data may include large amounts of free form text from various sources that include all types of consumer sentiment (e.g., positive, non-positive, negative, neutral, etc.). Analyzing free form text of the unstructured data may require large computer processing times and resources to understand consumer sentiment.

To address the computer processing time and resource issues, the systems and methods described herein may utilize generative artificial intelligence and machine learning techniques. As described in more detail below, the generative artificial intelligence techniques may be used to analyze large amounts of free form text data to understand consumer sentiment for transactions. The generative artificial intelligence techniques may identify positive consumer sentiment from the unstructured data. Further, the generative artificial intelligence techniques may also identify non-positive consumer sentiment from the unstructured data. The generative artificial intelligence techniques may convert or format the unstructured data into structured data that is acceptable for analysis by the processing engine. In other words, the generative artificial intelligence techniques may transform the unstructured data into structured data.

The machine learning techniques described herein may predict one or more steps for transactions. For example, the one or more steps predicted by the machine learning techniques may include positive consumer sentiment. The machine learning techniques may train a computer model using historical data, where the historical data may include historical pathways, steps, and/or consumer sentiment data for historical transactions. The computer model may predict one or more steps for transactions for new data. The one or more steps determined from the machine learning techniques may be used in part by the processing engine to determine a pathway for transactions.

The systems and methods described herein may utilize the consumer sentiment determination engine and/or the processing engine to accurately capture consumer sentiment for transactions. In particular, the systems and methods described herein may accurately capture positive consumer sentiment for transactions. The systems and method described herein may also accurately capture non-positive (e.g., negative, neutral) consumer sentiment for transactions. The systems and methods described herein may reduce processing times and resources used when analyzing large amounts of unstructured data to understand consumer sentiment as compared to manually reviewing the unstructured data or using a keyword search process to understand consumer sentiment. By following a pathway generated by the system, the consumer experience may be improved. Improving the transaction experience (e.g., purchasing a product or enrolling into a service) may lead to increased consumer satisfaction, which may in turn lead to consumer loyalty and consumer retention.

Further, the system and methods described herein may also build a historical database of consumer sentiment associated with transactions. The systems and methods described herein may utilize the historical database to guide future consumers on transaction pathways that may result in the future consumers having positive sentiment or positive experiences with the transaction. Further, the system may guide consumers on transaction pathways that include positive consumer sentiment in real-time. The system and methods described herein may actively generate updated transaction pathways and/or steps to maintain positive consumer sentiment during the transaction. The determination of transaction pathways and/or steps in real-time may lead to increased consumer satisfaction, loyalty, and retention for transactions.

### Computing Devices and Operating Environment

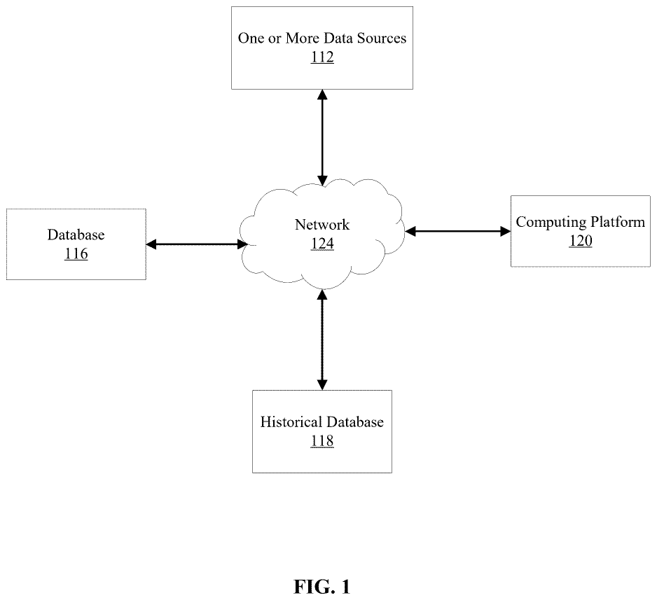

FIGS. 1-3 illustrate a computing environment for a pathway determination system 100 (or a transaction pathway determination system 100, or a system 100). The pathway determination system 100 may determine one or more pathways 104 comprising one or more steps 108 that guide consumers through a product, sales, or service transaction (generally referred to as “transaction”). The pathway determination system 100 may also determine consumer sentiment for the transaction, the pathway 104, and/or the one or more steps 108. The pathway determination system 100 may determine consumer sentiment or consumer experiences associated with the pathway 104 and/or the one or more steps 108. Referring to FIG. 1, the computing environment 100 may include one or more computing systems. For example, the pathway determination system 100 may include one or more data sources 112, a database 116, a historical database 118, and a computing platform 120.

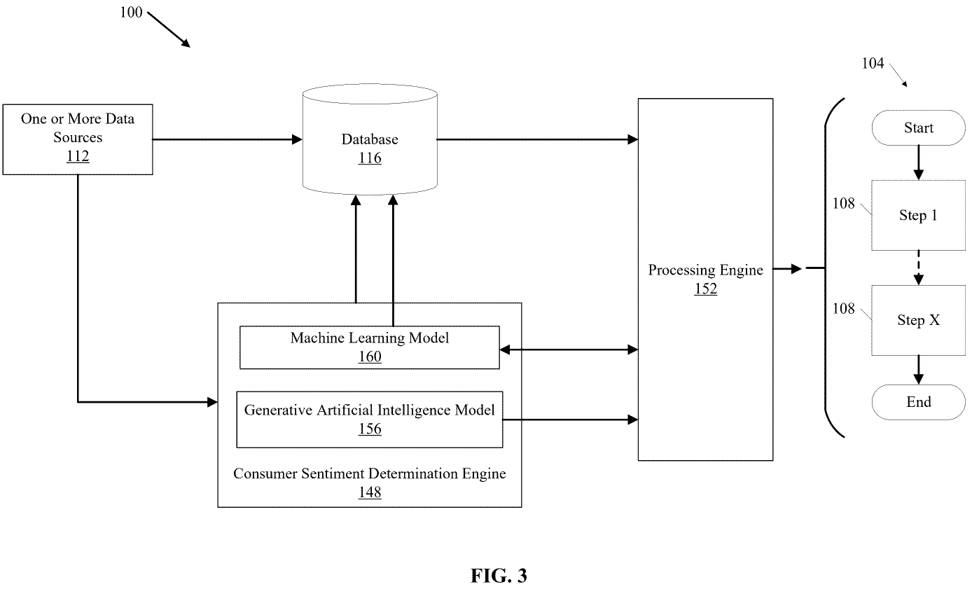

With reference to FIGS. 1 and 3, the one or more data sources 112 may include one or more computing devices or computer devices (e.g., servers, server blades, cloud-based servers, and/or other devices), and/or other components (e.g., processors, memories, communication interfaces). The one or more data sources 112 may be configured to store and provide data for transactions, and consumer sentiment associated with the transactions. In some embodiments, the data may include products, services, sales, insurance policies, policy data, communication data, consumer interaction data (e.g., consumer and enterprise, consumer and insurance agent), activities associated with a pathway or one or more steps, events associated with a pathway or one or more steps, survey data, endorsements, claims, third party subrogation, underwriting elements, and/or any combination thereof. The consumer sentiment data may include positive, non-positive, negative, or neutral consumer sentiment associated with the transactions. In some embodiments, the consumer sentiment data may include consumer sentiment on a scale (e.g., 1 to 10 scale, where 1 is mostly negative and 10 is mostly positive). In some embodiments, the consumer sentiment data may include varying degrees of consumer sentiment that ranges on a spectrum. In some embodiments, the consumer sentiment data may be consumer reviews, consumer ratings, consumer feedback, rate of consumer's acceptance of products or services, indication of product purchase, indication of service enrollment, consumer's feedback on a transaction step, consumer's feedback on a transaction pathway, etc. In other embodiments, the one or more data sources 112 may be configured to store and provide images, text, audio, and/or other data associated with transactions and consumer sentiment.

The one or more data sources 112 may be configured to store and provide structured data and unstructured data. The structured data may include data for transactions, and/or consumer sentiment associated with the transactions. Examples of structured data may include quantitative data that is organized and easily searchable, data that is organized in rows and columns, data tables, tabular data, JavaScript Object Notation, XML, word doc format, data that is searchable with a programming language such as Structured Query Language (SQL), Python, SQL databases, and/or any combination thereof.

The unstructured data may include data for consumer sentiment associated with transactions. Examples of unstructured data may include free from text data, text data converted from audio or chat conversations, text files, reports, survey data, phone calls, online chats, other text data, and/or any combination thereof. In some embodiments, the unstructured data may include text data converted from an audio conversation, a phone call or online chat dialog. In other embodiments, the one or more data sources 112 may be configured to store and provide one or more types of data (e.g., first, second, third, fourth, fifth data, etc.). The one or more data sources 112 may store and provide current data in real-time, at intervals, and/or continuously to one or more computing systems in the computing environment or the pathway determination system 100.

With continued reference to FIGS. 1 and 3, the database 116 may include one or more computers (e.g., server, server blades, or the like), and/or other computer components (e.g., processors, memories, communication interfaces). The database 116 may also be referred to as a staging database 116. The database 116 may be configured to store and provide data for transactions, and consumer sentiment associated with transactions. The database 116 may receive data from the one or more data sources 112. The database 116 may receive data from the computing platform 120.

In some embodiments, the database 116 may be configured to arrange, organize, or prepare data in a format acceptable for analyzing by the computing platform 120. For example, the database 116 may format data into a structured format. In some embodiments, the database 116 may be configured to filter and transform the stored data to reduce noise. For example, the database 116 may use or receive instructions to use SQL scripting to extract, transform, and load (ETL) the data stored in the database 116. For example, the database 116 may remove private information associated with consumers before analysis by the computing platform 120. The database 116 may receive and store data at intervals, continuously, and/or in real-time from one or more computing systems in the computing environment 100.

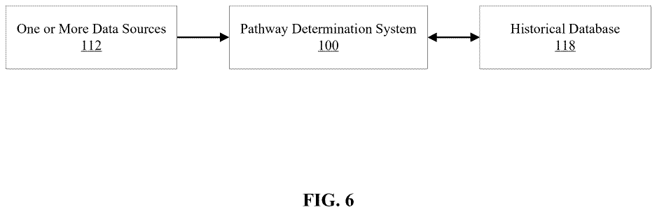

As shown in FIGS. 1 and 6, the historical database 118 may include one or more computers (e.g., server, server blades, or the like), and/or other computer components (e.g., processors, memories, communication interfaces). The historical database 118 may be configured to store and provide historical data associated with transactions. The historical data may include one or more products, one or more services, consumer sentiment associated with the transactions, consumer sentiment associated with a plurality of consumers, one or more steps for transactions, one or more pathways for transactions, structured data corresponding to one or more transactions, structured data corresponding to consumer sentiment, data that has been processed by the pathway determination system 100, and/or any combination thereof. The historical data may include examples of steps 108 or pathways 104 associated with positive consumer sentiment, steps 108 or pathways 104 associated with non-positive consumer sentiment, steps 108 or pathways 104 associated with negative consumer sentiment, steps 108 or pathways 104 associated with neutral consumer sentiment, and/or any combination thereof.

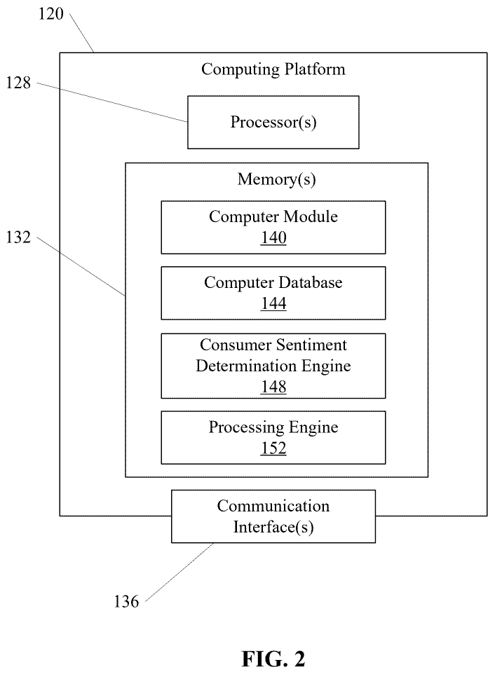

As described in greater detailed below and as shown in FIGS. 2 and 3, the computing platform 120 (or computer platform 120) may include one or more computer devices configured to perform one or more of the functions described herein. For example, the computing platform 120 may include one or more computers (e.g., laptop computers, desktop computers, servers, server blades, or the like), and/or other computer components (e.g., processors, memories, communications interfaces). As described in more detail below, the computing platform 120 may be configured to apply one or more methods to determine one or more pathways 104 having one or more steps 108 for transactions.

As shown in FIG. 1, the computing environment may also include one or more networks, which may interconnect the one or more data sources 112, the database 116, and the computing platform 120. The computing environment may further interconnect one or more other systems, public networks, sub-networks, and/or the like. For example, the computing environment may include a network 124. The network 124 may be a wired or wireless network 124, which may interconnect the one or more data sources 112, the database 116, and the computing platform 120. In other embodiments, the pathway determination system 100 may be connected to or in communication with other computing systems via the network 124. Further, as shown in FIG. 3, data or information may transfer or flow between the one or more data sources 112, the database 116, and the computing platform 120.

In one or more arrangements, the one or more data sources 112, the database 116, the computing platform 120, and/or other systems included in the computing environment may be any type of computer device capable of receiving a user interface, receiving input via the user interface, and/or communicating the received input to one or more other computing devices. For example, the systems included in the computer environment 100 may, in some examples, be and/or include server computers, desktop computers, laptop computers, tablet computers, smart phones, or the like that may include one or more processors, memories, communication interfaces, storage devices, and/or other components. As noted above, and as described in greater detail below, any and/or all of the one or more data sources 112, the database 116, and the computing platform 120 may be special-purpose computer devices configure to perform specific functions.

Referring to FIG. 2, the computing platform 120 may include one or more processors 128, a memory 132, and a communication interface 136. A data bus may interconnect processors 128, the memory 132, and the communication interface 136. The communication interface 136 may be a network interface configured to support communication between the computing platform 120 and one or more networks (e.g., network 124, or the like). The memory 132 may include one or more program modules having instructions that when executed by processor 128 cause the computing platform 120 to perform one or more functions described herein and/or one or more databases that may store and/or otherwise maintain information which may be used by such program modules and/or processor 128. In some embodiments, the program modules and/or the databases may be stored by and/or maintained in different memory units of the computing platform 120 and/or by different computer devices that may form and/or otherwise make up the computing platform 120.

With continued reference to FIG. 2, the memory 132 may have, store, and/or include a computer module 140, a computer database 144, a consumer sentiment determination engine 148, and a processing engine 152. Computer module 140 may have instructions that direct and/or cause the computing platform 120 to analyze data to identify consumer sentiment (e.g., positive, non-positive, negative, neutral, etc.) corresponding to transactions. The computer module 140 may have instructions that direct and/or cause the computing platform 120 to determine one or more pathways 104 comprising one or more steps 108 for transactions as described in more detail below.

As shown in FIG. 2, the computer database 144 may store information used by the computing platform 120, the computer module 140, the consumer sentiment determination engine 148, and the processing engine 152 in generating one or more pathways 104 comprising one or more steps 108 for transactions. The computer database 144 may store data in one or more formats. For example, the computer database 144 may store data in a structured format. For example, the computer database 144 may store data in an unstructured format. For example, the computer database 144 may store data in a structured format after analysis by the consumer sentiment determination engine 148 as described in more detail below. In some embodiments, the computer database 144 may store historical data as described in this disclosure. The computer database 144 may receive historical data from the one or more data sources 112.

### Consumer Sentiment Determination Engine and Processing Engine

With reference to FIGS. 2 and 3, the consumer sentiment determination engine 148 may include instructions that direct and/or cause the computing platform 120 to identify consumer sentiment associated with transactions. The consumer sentiment determination engine 148 may also be referred to as a machine learning engine 148 or an artificial intelligence engine 148. The consumer sentiment determination engine 148 may receive data from the one or more sources 112, the database 116, the historical database 118, or any combination thereof. For example, the consumer sentiment determination engine 148 may receive unstructured data for transactions. The consumer sentiment determination engine 148 may analyze the unstructured data for at least one type of consumer sentiment. The consumer sentiment determination engine 148 may analyze the unstructured data for varying degrees of consumer sentiment such as positive, non-positive, negative, neutral, and/or consumer sentiment on a scale or a spectrum.

The consumer sentiment determination engine 148 may include a generative artificial intelligence model 156 and a machine learning model 160. As described in more detail below, the consumer sentiment determination engine 148 may analyze unstructured data to determine consumer sentiment for transactions using the generative artificial intelligence model 156. The consumer sentiment determination engine 148 may predict or determine one or more steps 108 for transactions based on historical data using the machine learning model 160. The consumer sentiment determination engine 148 may also determine or calculate one or more scores for activities associated with one or more steps 108 of a pathway 104. In other words, the consumer sentiment determination engine 148 may determine or calculate one or more scores for events associated with one or more steps 108 of a pathway 104.

With reference to FIG. 3, the generative artificial intelligence model 156 may include a text-to-text language model or large language model. The generative artificial intelligence model 156 may include a neutral network, and/or other machine learning algorithms. The generative artificial intelligence model 156 may analyze data provided by the one or more data sources 112. For example, the generative artificial intelligence model 156 may analyze unstructured data corresponding to consumer sentiment associated with transactions. In some embodiments, the generative artificial intelligence model 156 reduces the computer processing time needed to analyze large amounts of unstructured data as compared to manually reviewing the unstructured data or developing a keyword search strategy in which the unstructured data may include a large variation in keywords. In some embodiments, the generative artificial intelligence model 156 may accurately capture consumer sentiment for transactions from unstructured data (rather than understanding consumer sentiment from structured data which may not include indications of consumer sentiment or low accuracy of consumer sentiment).

The generative artificial intelligence model 156 may analyze the unstructured data using a text analysis process. For example, the unstructured data may include free form text data. The text analysis process of the generative artificial intelligence model 156 may analyze free form text data provided by the one or more data sources 112. In some embodiments, a file or text file may include the free form text data. The text analysis process may analyze the free form text data to identify consumer sentiment (e.g., positive, non-positive, negative, neutral, etc.). The generative artificial intelligence model 156 may analyze the unstructured data by performing techniques including prompt engineering, multimodal analysis, other machine learning techniques, and/or other techniques. For example, in performing the prompt engineering, the computing platform 120 may receive a prompt including natural language text for use by the generative artificial intelligence model 156 to generate an output.

Further, in performing prompt engineering, the generative artificial intelligence model 156 may identify or parse positive consumer sentiment from the unstructured data based on one or more prompts. For example, the generative artificial intelligence model 156 may determine positive consumer sentiment from one or more steps 108 of transactions. The generative artificial intelligence model 156 may also identify or parse non-positive consumer sentiment from the unstructured data based on one or more prompts. For example, the one or more prompts may be generated to identify an event from the unstructured data. Examples of events may include positive consumer experiences such as product purchase, service enrollment, acceptance of feedback from insurance agent during a phone call, high rating on survey (i.e., 5/5 stars or 4/5 stars). Further, examples of events may include negative consumer experiences such as refusal to purchase product, refusal to enroll into a service, low rating on survey (i.e., 0/5 stars of 1/5 stars), renewal notification for a product or service. Other examples of events may include payment events, reminders, changes in details of a product or service, changes in details of a sale, changes in insurance policy details, and/or communications between consumers and external vendors (e.g., vehicle body shops). Still, in other examples, the events may include other consumer sentiment such as non-positive, negative, neutral, and/or consumer sentiment based on a scale or a spectrum. It should be understood that other examples of events may be contemplated in other embodiments.

The output of the generative artificial intelligence model 156 may include structured data associated with positive consumer sentiment. For example, the generative artificial intelligence model 156 may convert or transform the free form text data (i.e., unstructured data) into structured data. In some embodiments, the output of the generative artificial intelligence model 156 may include structured data indicating positive and non-positive consumer sentiment for transactions. For example, the structured data generated from the generative artificial intelligence model 156 may include a data table or tabular data having positive consumer sentiment, non-positive consumer sentiment, negative consumer sentiment, neutral consumer sentiment, and/or any combination thereof. For example, the structured data generated from the generative artificial intelligence model 156 may be included in a file.

With continued reference to FIG. 3, the machine learning model 160 may include instructions that direct and/or cause the computing platform 120 to determine one or more steps 108 for transactions based on historical data. The machine learning model 160 may determine steps 108 for transactions that include positive or non-positive consumer sentiment. In some embodiments, the machine learning model 160 may determine steps 108 for transactions that include successful completion of activities or events associated with the steps 108. The machine learning model 160 may receive the historical data from the one or more data sources 112 and/or the computer database 144 as an input. In some embodiments, the one or more steps 108 determined by the machine learning model 160 may supplement the determination of one or more pathways 104 via the processing engine 152 as described in more detail below. The machine learning model 160 may set, define, and/or iteratively refine optimization rules, techniques, and/or other parameters used by the computing platform 120 and/or other systems in the computing environment 100. In other embodiments, the computing platform 130 may include one or more machine learning models 160 that may be trained on different aspects of guiding consumers to complete transactions. For example, the one or more machine learning models 160 may include a machine learning model 160 trained on a particular product or service, or a machine learning model 160 trained to identify a consumer's risk for retention.

The computing platform 120 may train the machine learning model 160 to determine one or more steps 108 for transactions using the historical data. The machine learning model 160 may utilize one or more tools, or one or more models such as, for example, a linear regression, a decision tree, a support vector machine, a random forest, a k-means algorithm, gradient boosting algorithms, gradient boosted tree model algorithm, dimensionality reduction algorithms, and the like. The machine learning model 160 may be trained via supervised learning techniques to determine one or more steps 108 for transactions based on historical data.

In some embodiments, the machine learning model 160 may be trained to determine one or more steps 108 for transactions based on historical data having positive and negative cases. For example, the computing platform 120 may create the positive cases comprising one or more steps 108 associated with positive consumer sentiment. For example, the computing platform 120 may create the negative cases comprising one or more steps 108 associated with non-positive consumer sentiment. The machine learning model 160 may be trained to distinguish between the positive and negative cases to determine one or more steps 108 for future products, services, and/or consumers. In some embodiments, an output of the machine learning model 160 may be reviewed by a human operator. Accordingly, the output of the machine learning model 160 may be confirmed by the human operator or the consumer sentiment determination engine 148, and this may form additional training data for the machine learning model 160.

In some embodiments, the machine learning model 160 may determine or calculate a score for one or more activities (or one or more events) associated with one or more steps 108 of a pathway 104. In other words, a pathway 104 may include one or more activities or events associated with a transaction. The machine learning model 160 and/or the consumer sentiment determination engine 148 may use data or information received from one or more components of the pathway determination system 100 as described above to determine a score for one or more activities associated with the one or more steps 108. For example, the machine learning model 160 may determine to recommend activities or events that result in positive consumer sentiment or successful completion of the activities or events if the score is above a threshold. For example, if the score exceeds a threshold, then the consumer sentiment determination engine 148 may send the score and the associated activities or events to the processing engine 152 for processing. For example, the machine learning model 160 may determine to avoid particular activities or events that result in negative consumer sentiment or would result in non-completion if the score is below a threshold. For example, if the score is below the threshold, then the consumer sentiment determination engine 148 may not send or refrain from sending the activities or events to the processing engine 152. In other embodiments, the consumer sentiment determination engine 148 may send activities or events below a score threshold as context for the processing engine 152 to determine steps 108 or pathways 104 that result in successful completions of transactions, pathways, or purchases of products.

The output of the machine learning model 160 and/or the consumer sentiment determination engine 148 may include a numeric value that may represent a score for the activity or event associated with the step 108. In some embodiments, the score may be on a scale of 1 to 100, 1 to 5, 0.1 to 1, or any other scale. The score for the activity or event associated with the step 108 may be compared to one or more thresholds. The one or more thresholds may be defined by historical data indicating activities or events that resulted in positive sentiment, or activities or events that resulted in a consumer completing steps 108 or pathways 104. For example, the one or more thresholds may include retention thresholds, purchasing thresholds, consumer sentiment thresholds, or other thresholds associated with completing activities, events, steps 108, or pathways 104 for transactions. In examples associated with retention thresholds or risk of retention thresholds, the machine learning model 160 may output activities or events with a score above a threshold indicating a consumer may have a high likelihood of retention while completing the steps 108 of the pathway 104. In examples associated with consumer sentiment thresholds, the machine learning models 160 may output activities or events with a score above a threshold indicating a consumer has had a positive experience with the steps 108 of the pathway 104. The machine learning model 160 and/or the consumer sentiment determination engine 148 may send scored activities or events to the processing engine 152 in real-time, at intervals, periodically, or continuously. The scored activities or events may be used by the processing engine 148 to determine steps 108 and/or pathways 104 that result in positive consumer sentiment, completion of a transaction, or completion of a pathway 104 as described below.

With reference to FIG. 3, the consumer sentiment determination engine 148 may be in communication with one or both of the database 116 and the processing engine 152. For example, the generative artificial intelligence model 156 and/or the machine learning model 160 may be in communication with the one or both of the database 116 and the processing engine 152. The consumer sentiment determination engine 148 may send data to the database 116 and/or the processing engine 152. For example, the consumer sentiment determination engine 148 may send structured data corresponding to consumer sentiment to the database 116 and/or the processing engine 148. For example, the consumer sentiment determination engine 148 may send structured data corresponding to one or more steps 108 for transactions to the database 116 and/or the processing engine 152.

As shown in FIGS. 2 and 3, the processing engine 152 may include instructions that direct and/or cause the computing platform 120 to determine one or more pathways 104 comprising one or more steps 108 for transactions. For example, the pathway 104 and the steps 108 may be for a transaction of an insurance product such as an auto, a home, or a renter's insurance policy. For example, the steps 108 may be communications between a consumer and an insurance agent (e.g., email, telephone, online chat, etc.), consumer's review of the insurance product, consumer's review of the insurance quote, consumer's request to modify the insurance product, and/or consumer's interaction with an insurance company website. For example, the pathway 104 may include a series of communications between a consumer and an insurance agent (e.g., initial request, review of quote, modification of quote, final review by consumer, bind, purchase of insurance product) that completes a transaction of an insurance product.

The processing engine 152 may determine the pathways 104 and/or the steps 108 for transactions. For example, the processing engine 152 may receive structured data from one or both of the database 116 and the consumer sentiment determination engine 148. For example, the processing engine 152 may determine each step 108 for a pathway 104 that includes a positive consumer experience or positive consumer sentiment. The processing engine 152 may analyze steps 108 or pathways 104 that include non-positive consumer sentiment such as negative or neutral consumer sentiment. For example, the processing engine 152 may analyze pathways 104 and/or steps 108 that include varying degrees of consumer sentiment. For example, based on the pathways 104 and/or steps 108 that include varying degrees of consumer sentiment, the processing engine 152 may determine the pathway 104 and/or steps 108 that include positive consumer sentiment.

The processing engine 152 may generate an output comprising one or more pathways 104 comprising the one or more steps 108 for transactions. For example, the output may include a pathway 104 and/or steps 108 that include positive consumer sentiment. For example, the output may include a pathway 104 and/or steps 108 that include non-positive (e.g., negative, neutral) consumer sentiment. For example, the output of the processing engine 152 may include a graphical user interface (GUI), a file, a business process model in a business process model and notation format (“BPMN”), a report, etc. including the one or more pathways 104 comprising the one or more steps 108 for transactions.

In some embodiments, the consumer experience may be improved as pathways 104 and/or steps 108 are identified for transactions using the consumer sentiment determination engine 148 and/or the processing engine 152. For example, the pathways 104 and/or steps 108 identified by the consumer sentiment determination engine 148 and/or the processing engine 152 may be used to personalize the consumer experience such that the consumer may have a positive experience with the transaction. By personalizing the consumer experience, the pathway determination system 100 may identify patterns, trends, characteristics, factors, etc. in the pathways 104 and/or steps 108 that may result in the consumer having a positive experience with the transaction. For example, the pathway determination system 100 may generate a customized pathway 104 comprising one or more steps 108 for a particular consumer that results in positive sentiment or positive experiences with the transaction. The pathway determination system 100 may also identify non-positive pathways 104 and/or steps 108 that result in non-positive sentiment or non-positive experiences. The identification of non-positive pathways 104 and/or steps 108 may allow the pathway determination system 100 or enterprise to avoid transactions that have non-positive consumer experiences.

In some embodiments, the consumer experience may be personalized or customized by scoring activities or events associated with steps 108 as a consumer follows a pathway 104. For example, based on data associated with a consumer and machine learning insights (e.g., scores) from the consumer sentiment determination engine 148, the processing engine 152 may generate a pathway 104 with the highest likelihood that a consumer will complete a transaction, or purchase a product. In one example, the pathway determination system 100 may minimize the risk for retention of a consumer by generating a pathway 104 with steps 108 that include activities or events with scores above a threshold (e.g., defined by an enterprise, or defined by historical data indicating activities or events that resulted in positive consumer sentiment). The pathway determination system 100 may generate a pathway 104 including activities or events that retain a consumer on each step 108 of the pathway 104 to complete a transaction. The pathway determination system 100 may avoid recommending activities or events that may include a high level of risk for retention (e.g., activities or events that lead to a consumer not completing a transaction or purchasing a product).

### Determining Pathways and Consumer Sentiment for Transactions

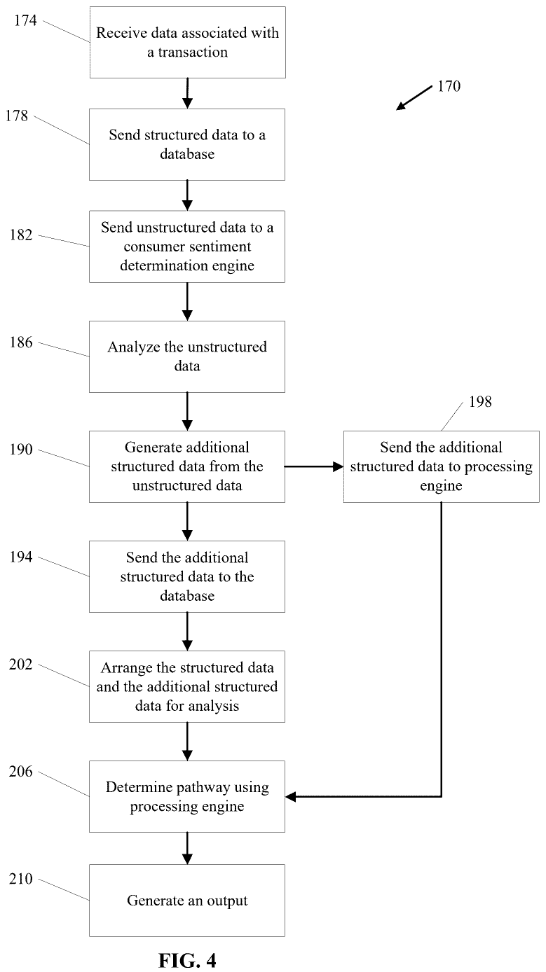

FIG. 4 is a flow chart illustrating a method 170 (or process 170) for determining a pathway 104 comprising one or more steps 108 for transactions according to one or more embodiments. The pathway 104 and/or the steps 108 may include positive consumer sentiment. Some or all of the steps of method 170 may be performed using one or more computing devices and/or combination thereof described in this disclosure. In a variety of embodiments, some or all of the steps described below may be combined and/or divided into sub-steps as appropriate.

Referring to FIGS. 3 and 4, at step 174, a computing platform 120 having at least one processor 128, a communication interface 136, and a memory 132 may receive data associated with a transaction from the one or more data sources 112. The data may include structured data and unstructured data. For example, the structured data may be associated with the transaction, and the unstructured data may be associated with consumer sentiment. For example, the structured data may be standardized data, and the unstructured data may be free form text data. The computing platform 120 may receive the data in intervals, continuously, and/or real-time from the one or more data sources 112. At step 178, the computing platform 120 may send the structured data to the database 116. In other embodiments, the structured data may be sent directly to the database 116 from the one or more data sources 112.

As shown in FIGS. 3 and 4, at step 182, the computing platform 120 may send the unstructured data to the consumer sentiment determination engine 148. In other embodiments, the unstructured data may be sent directly to the consumer sentiment determination engine 148 from the one or more data sources 112. At step 186, the consumer sentiment determination engine 148 may analyze the unstructured data to determine consumer sentiment for the transaction. More specifically, the computing platform 120 may use the generative artificial intelligence model 156 to analyze the unstructured data to determine consumer sentiment for the transaction. The generative artificial intelligence model 156 may use a text analysis process, prompt engineering, and/or other techniques as described in this disclosure to determine consumer sentiment from the unstructured data. Additionally, at step 186, the generative artificial intelligence model 156 may analyze the unstructured data for positive, non-positive, negative, and/or neutral consumer sentiment. For example, the generative artificial intelligence model 156 may analyze consumer sentiment on a scale or a spectrum. For example, the consumer sentiment determination engine 148 and/or the generative artificial intelligence model 156 may analyze the unstructured data for at least one type of consumer sentiment.

With continued reference to FIGS. 3 and 4, at step 190, the consumer sentiment determination engine 148 may generate an output using the generative artificial intelligence model 156. For example, the output of the generative artificial intelligence model 156 may include additional structured data. For example, the additional structured data may be in a similar format to the structured data provided by the one or more data sources 112. In other embodiments, the additional structured data may be in a different format than the structured data provide by the one or more data sources 112. For example, the additional structured data may include positive or non-positive consumer sentiment for the transaction. For example, the additional structured data may include a data table or tabular data corresponding to positive or non-positive consumer sentiment for the transaction.

At step 194, the computing platform 120 may store the additional structured data in the database 116. Additionally or alternatively, at step 198, the computing platform 120 may send the additional structured data directly to the processing engine 152. At step 202, the database 116 may organize or include instructions to organize the structured data and the additional structured data for analysis by the processing engine 152. For example, the database 116 may use SQL scripting to extract, transform, and load (ETL) the structured data and the additional structured data. For example, the database 116 may reduce noise or remove private consumer information from the structured data and the additional structured data.

As shown in FIGS. 3 and 4, at step 206, the computing platform 120 may analyze the structured data and the additional structured data using the processing engine 152. The processing engine 152 may determine a pathway 104 comprising one or more steps 108 for the transaction. The processing engine 152 may determine the pathway 104 and/or steps 108 that include positive consumer sentiment for the transaction. For example, the processing engine 152 may determine a pathway 104 for a transaction, where each step 108 includes positive consumer sentiment. For example, the pathway 104 may be for a particular insurance product such as home or automobile insurance. For example, the pathway 104 may be for a particular service such as vehicle tow service, vehicle non-tow service, claim submission, home security, vehicle security, etc.

At step 210, the computing platform 120 may generate an output. In some embodiments, the computing platform 120 may generate a report, a graphical user interface, or a file including the pathway 104 having one or more steps 108 for the transaction. The pathway 104 and/or the steps 108 may include positive consumer sentiment. The pathway 104 may include a flow chart, a diagram, or a map having one or more steps 108. In other embodiments, the computing platform 120 may generate one or more pathways 104 comprising one or more steps 108 for the transaction. The method 170 may lead to increased consumer satisfaction, loyalty, and/or retention for products, services, or enterprise offering the products or services.

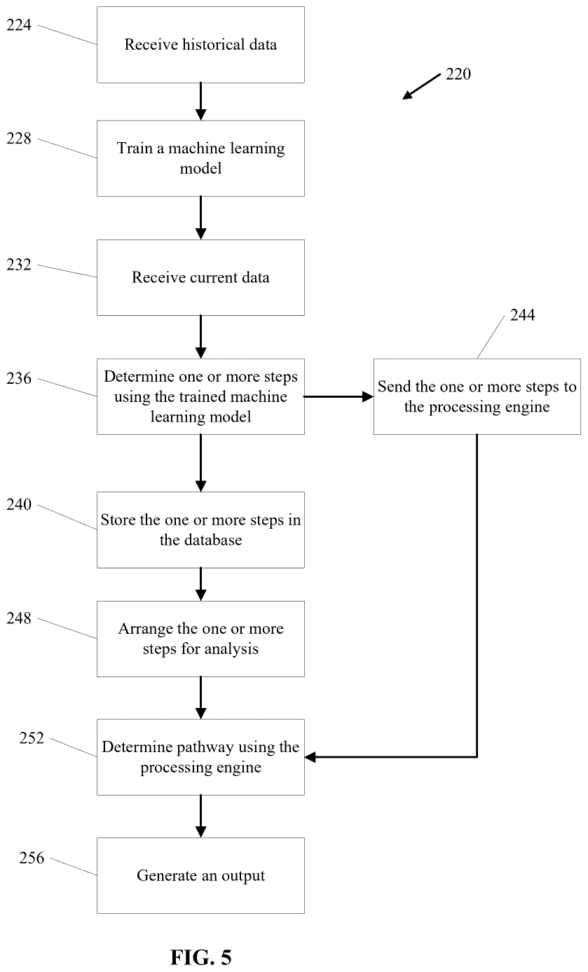

FIG. 5 is a flow chart illustrating a method or process 220 for determining a pathway 104 comprising one or more steps 108 for transactions according to one or more embodiments. Some or all of the steps of process 220 may be performed using one or more computing devices and/or combination thereof described in this disclosure. In a variety of embodiments, some or all of the steps described below may be combined and/or divided into sub-steps as appropriate. Further, some or all the steps of process 220 may be performed with process 170 in FIG. 4.

Referring to FIG. 5, at step 224, the computing platform 120 may receive historical data from the one or more data sources 112. In particular, the consumer sentiment determination engine 148 comprising the machine learning model 160 may receive the historical data from the historical database 118. At step 228, the computing platform 120 may train the machine learning model using the historical data. For example, the historical data may include one or more steps 108 for historical transactions, and the associated customer sentiment for the one or more steps 108.

With continued reference to FIG. 5, the computing platform 120 may select one or more tools, or one or more models based on the historical data as described in this disclosure. Once a tool or model is selected, the computing platform 120 may create positive and negative cases for training (e.g., label the historical data as positive or negative). For example, in creating the positive cases, the computing platform 120 may identify one or more steps 108 that include positive consumer sentiment (e.g., consumers indicated a positive consumer experience, consumers purchased a product, consumers enrolled into a service). In creating the negative cases, the computing platform 120 may identify one or more steps 108 that include non-positive consumer sentiment (e.g., consumer indicated a negative experience, consumers did not purchase a product, consumers did not enroll into a service, consumers indicated a neutral experience). The computing platform 120 may train the machine learning model 160 to distinguish between the positive and negative cases. The computing platform 120 may train the machine learning model 160 to predict or determine one or more steps 108 associated with positive consumer sentiment for future products, services, and/or consumers.

At step 232, the computing platform 120 may receive current data (e.g., new data) for a consumer from the one or more data sources 112. For example, the current data may include information associated with the consumer (e.g., name, address). For example, the current data may include product, sale, or service information associated with the consumer (e.g., product the consumer wants to purchase, service the consumer wants to enroll in). The computing platform 120 may receive the current data in intervals, continuously, and/or real-time.

At step 236, the computing platform 120 may determine one or more steps 108 for the transaction using the current data and trained machine learning model 160. The one or more steps 108 may be associated with positive consumer sentiment. In some embodiments, the one or more steps 108 determined at step 236 may be for the product the consumer wants to purchase. In some embodiments, the one or more steps 108 determined at step 236 may be for the service the consumer wants to enroll in. The trained machine learning model 160 may use the current data as an input to determine one or more steps 108 associated with positive consumer sentiment. In some embodiments, the computing platform 120 may use the machine learning model 160 to determine one or more scores for the one or more steps 108. The computing platform 120 may determine the one or more steps 108 that may be above a score threshold or below a score threshold.

At step 240, the computing platform 120 may store the one or more steps 108 determined at step 236 to the database 116. At step 248, the database 116 may organize or include instructions to organize the one or more steps 108 for analysis by the processing engine 152. For example, the one or more steps 108 may be in a structured data format, where the database 116 may arrange the structured data for analysis by the processing engine 152. Additionally or alternatively, at step 244, the computing platform 120 may send the one or more steps 108 determined at step 236 directly to the processing engine 152.

At step 244, the trained machine learning model 160 may communicate with the processing engine 152, where the processing engine 152 may provide feedback to the consumer sentiment determination engine 148 on whether the one or more steps 108 determined at step 236 includes positive consumer sentiment (FIG. 3). The consumer sentiment determination engine 148 may communicate back and forth (e.g., continuous, intervals, real-time) with the processing engine 152 until the one or more steps 108 determined by the trained machine learning model 160 generates a pathway 104 having positive consumer sentiment (e.g., positive consumer sentiment for each step 108, positive consumer sentiment for the entire pathway 104). For example, the trained machine learning model 160 may iterate the one or more steps 108 until each step 108 includes positive consumer sentiment. For example, the trained machine learning model 160 may iterate the one or more steps 108 until the processing engine 152 determines a pathway 104 for the transaction. For example, the trained machine learning model 160 may iterate until the steps 108 include positive consumer sentiment. For example, the trained machine learning model 160 may iterate until the steps 108 that include non-positive sentiment are separated or parsed away from the steps 108 that include positive sentiment.

At step 252, the computing platform 120 may determine a pathway 104 comprising one or more steps 108 for the transaction using the processing engine 152. The one or more steps 108 predicted or determined at step 236 may be used in part to determine a pathway 104 for the transaction. For example, at step 252, the pathway 104 and/or the steps 108 may include positive consumer sentiment. For example, at step 252, the processing engine 152 determine the pathway 104 using steps 104 scored by the machine learning model 160 and/or the consumer sentiment determination engine 148.

At step 256, the computing platform 120 may generate an output. The computing platform 120 may generate a graphical user interface including the pathway 104 comprising one or more steps 108 for the transaction. In some embodiments, the computing platform 120 may generate a report or a file including the pathway 104 with one or more steps 108 for the transaction that includes positive consumer sentiment. In some embodiments, the consumer may have a positive experience or positive sentiment for the transaction if the consumer follows the pathway 104 generated from the method 220. The method 220 may lead to increased consumer satisfaction, loyalty, and/or retention for products, services, or enterprise offering the products or services.

It should be understood that the process 220 of FIG. 5 is an example and that other methods with similar steps are contemplated. In such other methods, additional steps may be included or steps may be omitted. Also, other methods may change the order of any of the steps. For example, the one or more steps 108 determined by the trained machine learning model 160 at step 236 may be used in the process 170 of FIG. 4 in part to determine a pathway 104 comprising one or more steps 108 for a transaction.

### Building Consumer Sentiment Historical Database

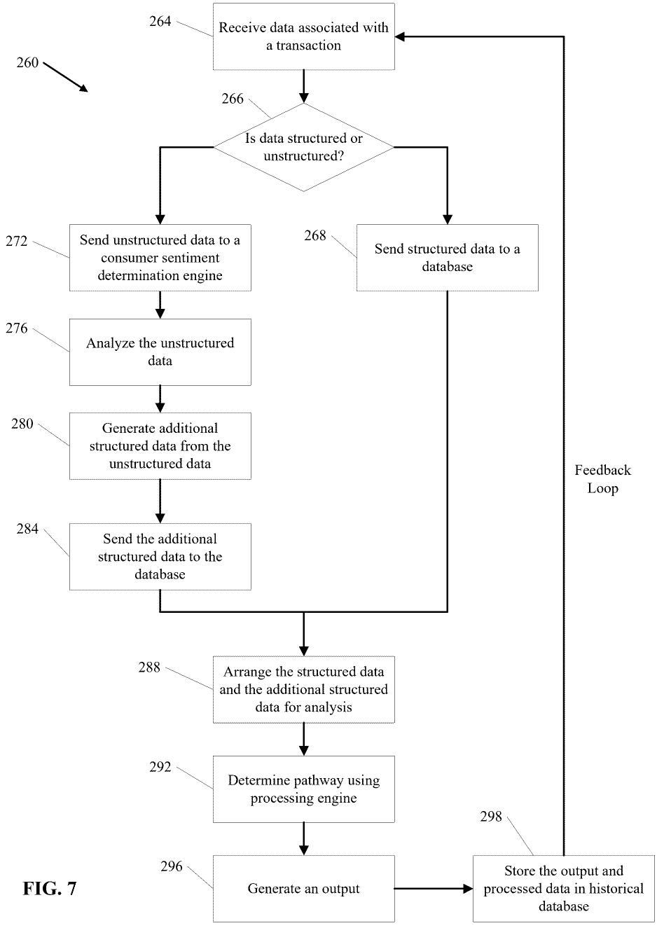

FIG. 7 is a flow chart illustrating a method 260 (or process 260) for collecting and analyzing consumer sentiment data for transactions according to one or more embodiments. FIG. 6 illustrates a data flow diagram showing the transfer of data between the one or more data sources 112, the transaction pathway determination system 100, and the historical database 118 according to one or more embodiments. Some or all of the steps of method 260 may be performed using one or more computing devices and/or combination thereof described in this disclosure. Some or all of the steps of method 260 may be performed in series, parallel, independently, separately, simultaneously, asynchronously, and/or any combination thereof. In a variety of embodiments, some or all of the steps described below may be combined and/or divided into sub-steps as appropriate.

Referring to FIGS. 6 and 7, at step 264, a computing platform 120 having at least one processor 128, a communication interface 136, and a memory 132 may receive data associated with a transaction from the one or more data sources 112. The data may include structured data and unstructured data. For example, the structured data may be associated with the transaction, and the unstructured data may be associated with consumer sentiment. For example, the structured data may be standardized data, and the unstructured data may be free form text data. The computing platform 120 may receive the data in intervals, continuously, and/or real-time from the one or more data sources 112. The computing platform 120 may be in communication with the pathway determination system 100. At step 266, the pathway determination system 100 may determine if the data includes structured data or unstructured data. At step 268, if the pathway determination system 100 determines the received data at step 264 includes structured data, then system 100 or the computing platform 120 may send the structured data to the database 116. In other embodiments, the structured data may be sent directly to the database 116 from the one or more data sources 112.

As shown in FIGS. 3 and 7, at step 272, if the pathway determination system 100 determines the received data at step 264 includes unstructured data, then the system 100 or the computing platform 120 may send the unstructured data to the consumer sentiment determination engine 148. In other embodiments, the unstructured data may be sent directly to the consumer sentiment determination engine 148 from the one or more data sources 112. At step 276, the consumer sentiment determination engine 148 may analyze the unstructured data to determine consumer sentiment for the transaction. More specifically, the computing platform 120 may use the generative artificial intelligence model 156 to analyze the unstructured data to determine consumer sentiment for the transaction. The generative artificial intelligence model 156 may use a text analysis process, prompt engineering, and/or other techniques as described in this disclosure to determine consumer sentiment from the unstructured data. At step 276, the generative artificial intelligence model 156 may analyze the unstructured data for positive, non-positive, negative, and/or neutral consumer sentiment. For example, the generative artificial intelligence model 156 may analyze consumer sentiment on a scale (e.g., 1 to 10, where 1 may be mostly negative and 10 may be mostly positive) or a spectrum. For example, the consumer sentiment determination engine 148 and/or the generative artificial intelligence model 156 may analyze the unstructured data for at least one type of consumer sentiment.

With continued reference to FIGS. 3 and 7, at step 280, the consumer sentiment determination engine 148 may generate an output using the generative artificial intelligence model 156. For example, the output of the generative artificial intelligence model 156 may include additional structured data. For example, the additional structured data may be in a similar format to the structured data provided by the one or more data sources 112. In other embodiments, the additional structured data may be in a different format than the structured data provide by the one or more data sources 112. For example, the additional structured data may include positive or non-positive consumer sentiment for the transaction. For example, the additional structured data may include a data table or tabular data corresponding to positive or non-positive consumer sentiment for the transaction.

At step 284, the computing platform 120 may send the additional structured data in the database 116. At step 288, the database 116 may organize or include instructions to organize the structured data and the additional structured data for analysis by the processing engine 152. For example, the database 116 may use SQL scripting to extract, transform, and load (ETL) the structured data and the additional structured data. For example, the database 116 may reduce noise or remove private consumer information from the structured data and the additional structured data.

As shown in FIGS. 3 and 7, at step 292, the computing platform 120 may analyze the structured data and the additional structured data using the processing engine 152. The processing engine 152 may determine a pathway 104 comprising one or more steps 108 for the transaction. The processing engine 152 may determine the pathway 104 and/or steps 108 that include positive consumer sentiment for the transaction. For example, the processing engine 152 may determine each step 108 of the pathway 104 includes positive consumer sentiment. For example, the pathway 104 may be for a particular insurance product such as home or automobile insurance. For example, the pathway 104 may be for a particular service such as vehicle tow service, vehicle non-tow service, claim submission, home security, vehicle security, sale of product, sale of service, etc.

At step 296, the computing platform 120 may generate an output. In some embodiments, the computing platform 120 may generate a report, a graphical user interface, or a file including the pathway 104 having one or more steps 108 for the transaction that includes positive consumer sentiment. The pathway 104 may include a flow chart, a diagram, a business process model (e.g., BPMN file format), or a map having one or more steps 108. In other embodiments, the computing platform 120 may generate one or more pathways 104 comprising one or more steps 108 for the transaction.

At step 298, the computing platform 120 may send and store the output to the historical database 118. The computing platform 120 may store the pathway 104 and/or one or more steps 108 determined at step 292 to the historical database 118. The computing platform 120 may also store the processed data, structured data, the additional structured data, other structured data, structured data associated with the transaction, and/or structured data associated with consumer sentiment (e.g., positive, non-positive, negative, neutral, scaled, spectrum) to the historical database 118.

The pathway determination system 100 may continue to operate and repeat the steps of method 260 as additional current or real-time data continues to be received. The pathway determination system 100 may utilize the method 260 for future consumers that complete transactions. The historical database 118 may include varying degrees of consumer sentiment for multiple transactions. The pathway determination system 100 may utilize the historical database 118 to determine pathways 104 and/or steps 108 for transactions for future consumers. By using the pathway determination system 100 and the historical database 118, future consumers may be placed on pathways 104 and/or steps 108 that include positive consumer sentiment, which may in turn lead to increased consumer satisfaction, loyalty, and retention.

### Guiding Consumers on One or More Transaction Pathways

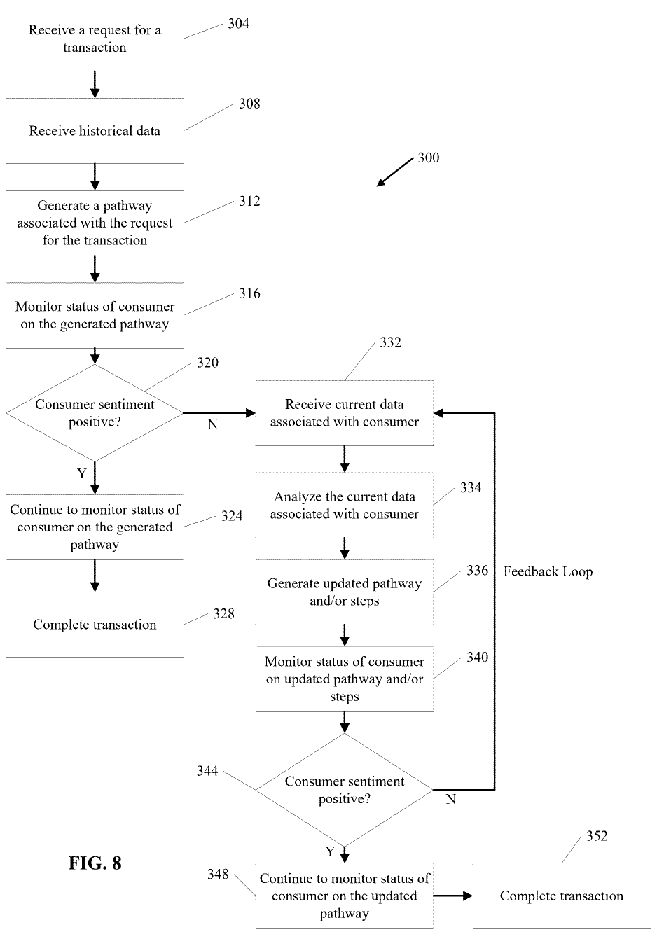

FIG. 8 is a flow chart illustrating a method 300 (or process 300) for guiding consumers on transaction pathways according to one or more embodiments. Some or all of the steps of method 300 may be performed using one or more computing devices and/or combination thereof described in this disclosure. In a variety of embodiments, some or all of the steps described below may be combined and/or divided into sub-steps as appropriate.

Referring to FIG. 8, at step 304, the pathway determination system 100 may receive a request for a product, a sale, or a service transaction (generally referred to as “transaction”) by a consumer. At step 308, the pathway determination system 100 may receive historical data associated with the product service from the historical database 118 (FIG. 6) and/or data associated with the consumer. For example, the historical data may include pathways 104 and/or steps 108 from historical transactions. In some embodiments, the transaction may be an insurance product such as an auto, a home, or a renter's insurance policy.

At step 312, the pathway determination system 100 may generate a pathway 104 comprising one or more steps 108 associated with the transaction request. In some embodiments, the pathway determination system 100 may generate a pathway 104 comprising one or more steps 108 that may be above a score threshold (e.g., likelihood that a consumer completes the step 108 and/or pathway 104, positive consumer sentiment threshold) by the consumer sentiment determination engine 148. In other words, the generated pathway 104 may include activities or events associated with the steps 108 that may be above a score threshold. At step 316, the pathway determination system 100 may monitor a consumer on the pathway 104 generated at step 312. For example, an insurance agent of an insurance company may monitor the consumer on the pathway 104 during the transaction. Further, at step 316, the pathway determination system 100 may receive data associated with the consumer as the consumer completes steps 108 of the pathway 104. The received data associated with the consumer may be received continuously, at intervals, and/or in real-time as the consumer completes steps 108 of the pathway 104.

Based on the received data associated with the consumer at step 316, the pathway determination system 100 may determine if the consumer has positive sentiment, positive experiences, and/or a neutral sentiment following the steps 108 of the pathway 104. If the pathway determination system 100 determines the consumer has positive sentiment or positive experiences following the pathway 104 and/or the steps 108 (i.e., Yes at step 320), then the pathway determination system 100 may continue to monitor the consumer. At step 324, the pathway determination system 100 may continue to monitor the consumer on the pathway 104 as the consumer completes steps 108 of the pathway 104. The pathway determination system 100 may ensure the consumer has positive sentiment or at least neutral sentiment while following the steps 108 of the pathway 104. At step 328, the consumer may complete all the steps 108 of the pathway 104 for the transaction. After completing the pathway 104 and/or steps 108 generated at step 312, the consumer may have positive sentiment or a positive experience with the transaction.

Alternatively, or additionally, if the pathway determination system 100 determines the consumer has a non-positive sentiment or non-positive experiences following the pathway 104 and/or the steps 108 (i.e., No at step 320), then the pathway determination system 100 may receive the current data associated with the consumer. At step 332, the pathway determination system 100 may receive data in real-time associated with consumer following the pathway 104 and/or steps 108 generated at step 312. For example, the pathway determination system 100 may receive consumer sentiment data associated with each step 108 and/or the pathway 104. For example, the pathway determination system 100 may receive non-positive consumer sentiment data which may include negative sentiment, neutral sentiment, sentiment on a low scale (e.g., 5 or less), and/or sentiment on a low end of a spectrum. For example, the pathway determination system 100 may receive unstructured data associated with consumer sentiment.

At step 334, the pathway determination system 100 may analyze the current data associated with the consumer. For example, the pathway determination system 100 may analyze the unstructured data using the consumer sentiment determination engine 148 as described in this disclosure. For example, the pathway determination system 100 may analyze the unstructured data in real-time using the consumer sentiment determination engine 148. At step 336, based on the analysis of the current data associated with the consumer, the pathway determination system 100 may generate an updated pathway 104 and/or updated steps 108. The pathway determination system 100 may determine the updated pathway 104 and/or updated steps 108 that result in positive consumer sentiment. For example, the pathway determination system 100 may utilize the historical database 118 to identify pathways 104 and/or steps 108 that resulted in positive consumer sentiment. For example, the updated pathway 104 and/or updated steps 108 generated at step 336 may bring the consumer back on a positive sentiment path or positive communication path for the transaction.

At step 340, the pathway determination system 100 may monitor the consumer on the updated pathway 104 and/or updated steps 108 generated at step 336. At step 344, the pathway determination system 100 may determine if the consumer has positive sentiment, positive experiences, and/or a neutral sentiment with the updated pathway 104 and/or updated steps 108. If the pathway determination system 100 determines the consumer has non-positive consumer sentiment, then the pathway determination system 100 may continue to operate and repeat steps 332, 334, 336, 340 as additional current or real-time data continues to be received. The pathway determination system 100 may continue to operate until the consumer has positive sentiment or positive experiences with the updated pathway 104 and/or updated steps 108.

If the pathway determination system 100 determines the consumer has positive sentiment toward the updated pathway 104 and/or updated steps 108, the pathway determination system 100 may continue to monitor the consumer following the updated pathway 104 and/or updated steps 108. The pathway determination system 100 may ensure the consumer has positive sentiment or at least neutral sentiment while following the updated steps 108 of the updated pathway 104. At step 352, the consumer may complete all the updated steps 108 of the updated pathway 104 for the transaction. After completing the updated pathway 104 and/or updated steps 108 generated at step 336, the consumer may leave the transaction with positive sentiment or with a positive experience. The updated pathway 104 and/or steps 108 may lead to an improved consumer experience when completing transactions, which may lead to increased satisfaction, loyalty, and/or retention.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of “at least one” component, element, etc., should not be used to create an inference that the alternative use of articles “a” or “an” should be limited to a single component, element, etc. It is further noted that recitations herein of “a”, “an”, “the”, “at least one”, and “one or more” are used interchangeably to indicate that at least one of the item is present and a plurality of such items may be present unless the context clearly indicates otherwise. It is also noted that recitations herein of a component of the present disclosure being “configured” or “programed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Representative Features

Representative features are set out in the following clauses, which stand alone or may be combined, in any combination, with one or more features disclosed in the text and/or drawings of the specification.

Clause 1. A computing system comprising: a processor; a memory storing computer-executable instructions that, when executed by the processor, cause the processor to: receive, by a computing device, data associated with a transaction pathway from one or more data sources, the data including at least one of structured data or unstructured data; analyze, by the computing device and via a machine learning model, the at least one of the structured data or the unstructured data to identify at least one type of consumer sentiment associated with the transaction pathway, the machine learning model trained on historical transaction pathway data and historical consumer sentiment data; store, by the computing device and based on the analysis, processed consumer sentiment data in a database; predict, by the computing device and via the machine learning model and based on the processed consumer sentiment data, one or more transaction steps, wherein each of the one or more transaction steps include a corresponding score above a predetermined consumer sentiment threshold; determine, by the computing device and via a processing engine in communication with the machine learning model and the database, a recommended transaction pathway that comprises the one or more transaction steps characterized by the corresponding score above the predetermined consumer sentiment threshold; and monitor, by the computing device, consumer sentiment data associated with recommended transaction pathway until a consumer completes the recommended transaction pathway.

Clause 2. The computing system of Clause 1, wherein the at least one type of consumer sentiment includes a positive consumer sentiment, a negative consumer sentiment, or a non-positive consumer sentiment.

Clause 3. The computing system of any of Clause 1 to Clause 2, wherein the predetermined consumer sentiment threshold is determined by the processed consumer sentiment data including indicators of at least one of a neutral consumer sentiment or a positive consumer sentiment.

Clause 4. The computing system of any of Clause 1 to Clause 3, wherein the structured data includes a data table or tabular data.

Clause 5. The computing system of any of Clause 1 to Clause 4, wherein the unstructured data includes free form text data from consumer communications.

Clause 6. The computing system of any of Clause 1 to Clause 5, wherein the computer-executable instructions, when executed by the processor, cause the processor to: convert, by the computing device and using the machine learning model, the unstructured data into the processed consumer sentiment data, the processed consumer sentiment data including additional structured data; and format, by the computing device and via the database, the structured data and the additional structured data in a format acceptable for analyzing by the processing engine; and determining, by the computing device and via the processing engine and based on the structured data and the additional structured data, the recommended transaction pathway.

Clause 7. The computing system of any of Clause 1 to Clause 6, wherein the computer-executable instructions, when executed by the processor, cause the processor to: monitor, in real-time via the computing device, the consumer sentiment data associated with the recommended transaction pathway; determine, by the computing device and in response to detecting non-positive sentiment, updated one or more transaction steps that resulted in positive consumer sentiment; update, in real-time via the computing device, the recommended transaction pathway with the updated one or more transaction steps; and monitor, in real-time via by the computing device, the consumer sentiment data associated with the recommended transaction pathway until the consumer completes the recommended transaction pathway.

Clause 8. A method comprising: receiving, by a computing device, data associated with a transaction pathway from one or more data sources, the data including at least one of structured data or unstructured data; analyzing, by the computing device and via a machine learning model, the at least one of the structured data or the unstructured data to identify at least one type of consumer sentiment associated with the transaction pathway, the machine learning model trained on historical transaction pathway data and historical consumer sentiment data; storing, by the computing device and based on the analyzing, processed consumer sentiment data in a database; predicting, by the computing device and via the machine learning model and based on the processed consumer sentiment data, one or more transaction steps, wherein each of the one or more transaction steps include a score above a predetermined consumer sentiment threshold; determining, by the computing device and via a processing engine in communication with the machine learning model and the database, a recommended transaction pathway that comprises the one or more transaction steps characterized by the corresponding score above the predetermined consumer sentiment threshold; and monitoring, by the computing device, consumer sentiment data associated with the recommended transaction pathway until a consumer completes the recommended transaction pathway.

Clause 9. The method of Clause 8, wherein the at least one type of consumer sentiment includes a positive consumer sentiment, a negative consumer sentiment, or a non-positive consumer sentiment.

Clause 10. The method of any of Clause 8 to Clause 9, wherein the predetermined consumer sentiment threshold is determined by the processed consumer sentiment data including indicators of at least one of a neutral consumer sentiment or a positive consumer sentiment.

Clause 11. The method of any of Clause 8 to Clause 10, wherein the structured data includes a data table or tabular data.

Clause 12. The method of any of Clause 8 to Clause 11, wherein the unstructured data includes free form text data from consumer communications.

Clause 13. The method of any of Clause 8 to Clause 12, further comprising: converting, by the computing device and using the machine learning model, the unstructured data into the processed consumer sentiment data, the processed consumer sentiment data including additional structured data; formatting, by the computing device and via the database, the structured data and the additional structured data in a format acceptable for analyzing by the processing engine; and determining, by the computing device and via the processing engine and based on the structured data and the additional structured data, the recommended transaction pathway.

Clause 14. The method of any of Clause 9 to Clause 13, further comprising: monitoring, in real-time via the computing device, the consumer sentiment data associated with the recommended transaction pathway; determining, by the computing device and in response to detecting non-positive sentiment, updated one or more transaction steps that resulted in positive consumer sentiment; updating, in real-time via the computing device, the recommended transaction pathway to include the updated one or more transaction steps; and monitoring, in real-time via the computing device, the consumer sentiment data associated with the recommended transaction pathway until the consumer completes the recommended transaction pathway.

Clause 15. One or more non-transitory computer-readable media storing instructions that, when executed by a processor, cause the processor to: receive, by a computing device, data associated with a transaction pathway from one or more data sources, the data including at least one of structured data or unstructured data; analyze, by the computing device and via a machine learning model, the at least one of the structured data or the unstructured data to identify at least one type of consumer sentiment associated with the transaction pathway, the machine learning model trained on historical transaction pathway data and historical consumer sentiment data; store, by the computing device and based on the analysis, processed consumer sentiment data in a database; predict, by the computing device and via the machine learning model and based on the processed consumer sentiment data, one or more transaction steps, wherein each of the one or more transaction steps include a corresponding score above a predetermined consumer sentiment threshold; determine, by the computing device and via a processing engine in communication with the machine learning model and the database, a recommended transaction pathway that comprises the one or more transaction steps characterized by the corresponding score above the predetermined consumer sentiment threshold; and monitor, by the computing device, consumer sentiment data associated with the recommended transaction pathway until a consumer completes the recommended transaction pathway.

Clause 16. The non-transitory computer-readable media storing instructions of Clause 15, wherein the at least one type of consumer sentiment includes a positive consumer sentiment, a negative consumer sentiment, or a non-positive consumer sentiment.

Clause 17. The non-transitory computer-readable media storing instructions of any of Clause 15 to Clause 16, wherein the predetermined consumer sentiment threshold is determined by the processed consumer sentiment data including indicators of at least one of a neutral consumer sentiment or a positive consumer sentiment.

Clause 18. The non-transitory computer-readable media storing instructions of any of Clause 15 to Clause 17, wherein the structured data includes a data table or tabular data.

Clause 19. The non-transitory computer-readable media storing instructions of any of Clause 15 to Clause 18, wherein the unstructured data includes free form text data from consumer communications.

Clause 20. The non-transitory computer-readable media storing instructions of any of Clause 15 to Clause 19, wherein when executed by the processor, cause the processor to: convert, by the computing device and using the machine learning model, the unstructured data into the processed consumer sentiment data, the processed consumer sentiment data including additional structured data; format, by the computing device and via the database, the structured data and the additional structured data in a format acceptable for analyzing by the processing engine; and determining, by the computing device and via the processing engine and the structured data and the additional structured data, the recommended transaction pathway.

Clause 21. A computing platform comprising: at least one processor; a communication interface communicatively coupled to the at least one processor; and memory storing machine readable instructions that, when executed by the at least one processor, cause the computing platform to: receive data associated with a transaction from one or more data sources, the data including structured data and unstructured data; a consumer sentiment determination engine communicatively coupled to the at least one processor and the memory and configured to: receive the unstructured data from the one or more data sources; perform a text analysis process on the unstructured data, wherein the performing of the text analysis process includes analyzing the unstructured data for at least one type of consumer sentiment associated with the transaction; convert the unstructured data into additional structured data corresponding to the at least one type of consumer sentiment; a database communicatively coupled to the at least one processor and the memory and configured to: store the structured data and the additional structured data; organize the structured data and the additional structured data in a format acceptable for analyzing; a processing engine communicatively coupled to the at least one processor and the memory and configured to: receive the structured data and the additional structured data from the database; determine, based on the structured data and the additional structured data, a pathway comprising one or more steps for the transaction, wherein the pathway results in at least one of a neutral consumer sentiment or a positive consumer sentiment.

Clause 22. The computing platform of Clause 21, further comprising machine readable instructions stored in the memory that, when executed by the at least one processor, cause the consumer sentiment determination engine to: execute the text analysis process using a machine learning model, wherein the machine learning model converts the unstructured data into the additional structured data.

Clause 23. The computing platform of any of Clause 21 to Clause 22, wherein the consumer sentiment determination engine is configured to generate a file comprising the additional structured data.

Clause 24. The computing platform of any of Clause 21 to Clause 23, wherein the at least one type of consumer sentiment includes a positive consumer sentiment, a negative consumer sentiment, or a non-positive consumer sentiment.

Clause 25. The computing platform of any of Clause 21 to Clause 24, wherein the unstructured data includes free form text data, and wherein a machine learning model converts the free form text data into the additional structured data.

Clause 26. The computing platform of any of Clause 21 to Clause 25, wherein the additional structured data includes a data table or tabular data.

Clause 27. The computing platform of any of Clause 21 to Clause 26, further comprising machine readable instructions stored in the memory that, when executed by the at least one processor, cause the consumer sentiment determination engine to: receive a text file from the one or more data sources, the text file including the unstructured data; convert, via a machine learning model, the unstructured data into the additional structured data; and generate, via the machine learning model, a new text file including the additional structured data.

It is noted that one or more of the following claims utilized the term “wherein” as a transitional phrase. For the purposes of defining the present disclosure, it noted that his term is an open-ended transitional term that is used to introduce a recitation of a series of characteristics of the structure and should be interpreted in like manner as the more commonly used open-ended preamble term “comprising.”

Aspects of the disclosure have been described in terms of illustrative embodiment thereof. Numerous other embodiments, modifications, and variations within the scope and spirit of the appended claims will occur to persons of ordinary skill in the art from a review of this disclosure. For example, one or more steps depicted in the illustrative figures may be performed in a different order other than the recited order, and one or more depicted steps may be optional in accordance with aspects of the disclosure.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computing system comprising:
a processor;
a memory storing computer-executable instructions that, when executed by the processor, cause the processor to:
receive, by a computing device, data associated with a transaction pathway from one or more data sources, the data including at least one of structured data or unstructured data;
analyze, by the computing device and via a machine learning model, the at least one of the structured data or the unstructured data to identify at least one type of consumer sentiment associated with the transaction pathway, the machine learning model trained on historical transaction pathway data and historical consumer sentiment data;
store, by the computing device and based on the analysis, processed consumer sentiment data in a database;
predict, by the computing device and via the machine learning model and based on the processed consumer sentiment data, one or more transaction steps, wherein each of the one or more transactions steps include a corresponding score above a predetermined consumer sentiment threshold;
determine, by the computing device and via a processing engine in communication with the machine learning model and the database, a recommended transaction pathway that comprises the one or more transaction steps characterized by the corresponding score above the predetermined consumer sentiment threshold; and
monitor, by the computing device, consumer sentiment data associated with recommended transaction pathway until a consumer completes the recommended transaction pathway.

2. The computing system of claim 1, wherein the at least one type of consumer sentiment includes a positive consumer sentiment, a negative consumer sentiment, or a non-positive consumer sentiment.

3. The computing system of claim 1, wherein the predetermined consumer sentiment threshold is determined by the processed consumer sentiment data including indicators of at least one of a neutral consumer sentiment or a positive consumer sentiment.

4. The computing system of claim 1, wherein the structured data includes a data table or tabular data.

5. The computing system of claim 1, wherein the unstructured data includes free form text data from consumer communications.

6. The computing system of claim 1, wherein the computer-executable instructions, when executed by the processor, cause the processor to:
convert, by the computing device and using the machine learning model, the unstructured data into the processed consumer sentiment data, the processed consumer sentiment data including additional structured data; and
format, by the computing device and via the database, the structured data and the additional structured data in a format acceptable for analyzing by the processing engine; and
determining, by the computing device and via the processing engine and based on the structured data and the additional structured data, the recommended transaction pathway.

7. The computing system of claim 1, wherein the computer-executable instructions, when executed by the processor, cause the processor to:
monitor, in real-time via the computing device, the consumer sentiment data associated with the recommended transaction pathway;
determine, by the computing device and in response to detecting non-positive sentiment, updated one or more transaction steps that resulted in positive consumer sentiment;
update, in real-time via the computing device, the recommended transaction pathway with the updated one or more transaction steps; and
monitor, in real-time via by the computing device, the consumer sentiment data associated with the recommended transaction pathway until the consumer completes the recommended transaction pathway.

8. A method comprising:
receiving, by a computing device, data associated with a transaction pathway from one or more data sources, the data including at least one of structured data or unstructured data;
analyzing, by the computing device and via a machine learning model, the at least one of the structured data or the unstructured data to identify at least one type of consumer sentiment associated with the transaction pathway, the machine learning model trained on historical transaction pathway data and historical consumer sentiment data;
storing, by the computing device and based on the analyzing, processed consumer sentiment data in a database;
predicting, by the computing device and via the machine learning model and based on the processed consumer sentiment data, one or more transaction steps, wherein each of the one or more transactions steps include a corresponding score above a predetermined consumer sentiment threshold;
determining, by the computing device and via a processing engine in communication with the machine learning model and the database, a recommended transaction pathway that comprises the one or more transaction steps characterized by the corresponding score above the predetermined consumer sentiment threshold; and
monitoring, by the computing device, consumer sentiment data associated with the recommended transaction pathway until a consumer completes the recommended transaction pathway.

9. The method of claim 8, wherein the at least one type of consumer sentiment includes a positive consumer sentiment, a negative consumer sentiment, or a non-positive consumer sentiment.

10. The method of claim 8, wherein the predetermined consumer sentiment threshold is determined by the processed consumer sentiment data including indicators of at least one of a neutral consumer sentiment or a positive consumer sentiment.

11. The method of claim 8, wherein the structured data includes a data table or tabular data.

12. The method of claim 8, wherein the unstructured data includes free form text data from consumer communications.

13. The method of claim 8, further comprising:
converting, by the computing device and using the machine learning model, the unstructured data into the processed consumer sentiment data, the processed consumer sentiment data including additional structured data;
formatting, by the computing device and via the database, the structured data and the additional structured data in a format acceptable for analyzing by the processing engine; and
determining, by the computing device and via the processing engine and based on the structured data and the additional structured data, the recommended transaction pathway.

14. The method of claim 8, further comprising:
monitoring, in real-time via the computing device, the consumer sentiment data associated with the recommended transaction pathway;
determining, by the computing device and in response to detecting non-positive sentiment, updated one or more transaction steps that resulted in positive consumer sentiment;
updating, in real-time via the computing device, the recommended transaction pathway to include the updated one or more transaction steps; and
monitoring, in real-time via the computing device, the consumer sentiment data associated with the recommended transaction pathway until the consumer completes the recommended transaction pathway.

15. One or more non-transitory computer-readable media storing instructions that, when executed by a processor, cause the processor to:
receive, by a computing device, data associated with a transaction pathway from one or more data sources, the data including at least one of structured data or unstructured data;
analyze, by the computing device and via a machine learning model, the at least one of the structured data or the unstructured data to identify at least one type of consumer sentiment associated with the transaction pathway, the machine learning model trained on historical transaction pathway data and historical consumer sentiment data;
store, by the computing device and based on the analysis, processed consumer sentiment data in a database;
predict, by the computing device and via the machine learning model and based on the processed consumer sentiment data, one or more transaction steps, wherein each of the one or more transactions steps include a corresponding score above a predetermined consumer sentiment threshold;
determine, by the computing device and via a processing engine in communication with the machine learning model and the database, a recommended transaction pathway that comprises the one or more transaction steps characterized by the corresponding score above the predetermined consumer sentiment threshold; and
monitor, by the computing device, consumer sentiment data associated with the recommended transaction pathway until a consumer completes the recommended transaction pathway.

16. The non-transitory computer-readable media storing instructions of claim 15, wherein the at least one type of consumer sentiment includes a positive consumer sentiment, a negative consumer sentiment, or a non-positive consumer sentiment.

17. The non-transitory computer-readable media storing instructions of claim 15, wherein the predetermined consumer sentiment threshold is determined by the processed consumer sentiment data including indicators of at least one of a neutral consumer sentiment or a positive consumer sentiment.

18. The non-transitory computer-readable media storing instructions of claim 15, wherein the structured data includes a data table or tabular data.

19. The non-transitory computer-readable media storing instructions of claim 15, wherein the unstructured data includes free form text data from consumer communications.

20. The non-transitory computer-readable media storing instructions of claim 15, wherein when executed by the processor, cause the processor to:
convert, by the computing device and using the machine learning model, the unstructured data into the processed consumer sentiment data, the processed consumer sentiment data including additional structured data;
format, by the computing device and via the database, the structured data and the additional structured data in a format acceptable for analyzing by the processing engine; and
determining, by the computing device and via the processing engine and the structured data and the additional structured data, the recommended transaction pathway.
